(19) United States
(12) Patent Application Publication
(10) Pub. No.: US 2015/0268443 A1
(43) Pub. Date: Sep. 24, 2015

(54) Optical Device

(71) Applicants: Sintai Optical (Shenzhen) Co., Ltd., Shenzhen City (CN); Asia Optical International Ltd., Tortola (GB)

(72) Inventors: Chun-Hung Huang, Taichung (TW); Wei-Shen Hung, Taichung (TW)

(21) Appl. No.: 14/665,129

(22) Filed: Mar. 23, 2015

(30) Foreign Application Priority Data
Mar. 24, 2014 (TW) 103110830

(51) Int. Cl. G02B 7/10; G03B 3/10

(52) U.S. Cl. CPC G02B 7/10; G03B 3/10

(57) ABSTRACT

An optical device is provided wherein an image sensor is disposed on a base, a cam barrel is rotatably disposed on the base and has a first cam groove and a second cam groove, a first motor is connected to the cam barrel and drives the cam barrel rotating with respect to a first axis, a straight barrel is disposed on the base and within the cam barrel and has at least one straight groove and parallel to the first axis, a first lens frame is joined to the first cam groove via the straight groove, a second lens frame is movable on a rail which axially extends on inner surfaces of the straight barrel, a third lens frame is joined to the second cam groove via the straight groove and a second motor drives the second lens frame to move along the rail. The cam barrel rotates to drive the first lens frame and the third lens frame moving along the straight groove.

### BACKGROUND OF THE INVENTION

1. Field of the Invention

The invention relates to an optical device having a plurality of lens frames, and more particularly to an optical device having a plurality of lens frames driven by several driving sources.

2. Description of the Related Art

An optical lens with zoom function often includes several lens frames, and each lens frame bears a lens group. The zoom function of the optical lens is accomplished by moving the lens frames to change the relative positions of the lens frames. Conventional optical lens with zoom function are disclosed in, for example, Taiwan patent No. 1252941, 1339746 and 1359293.

Referring to FIG. 1, a conventional optical lens includes a first lens frame 10, a second lens frame 20 and a third lens frame 30. The first lens frame 10 bears lens groups 12, 14 and 16, the second lens frame 20 bears a lens group 22, and the third lens frame 30 bears a lens group 32. The lens group 22 is a focus lens group. The first lens frame 10 has pins 18 joined to cam grooves 42 of a cam barrel 40 and also joined to another cam barrel 40′. The second lens frame 20 is joined to a focus motor (not shown). The third lens frame 30 has pins 34 joined to a rotational barrel 50. In operation, the rotational barrel 50 is rotated by a zoom motor (not shown) so as to move the third lens frame 30 along an optical axis of the lens group 32. The rotational barrel 50 rotates the cam barrels 40 and 40′, and the first lens frame 10 is moved by the cam grooves 42 of the cam barrel 40 along the optical axis of the lens groups 12, 14 and 16. The second lens frame 20 is moved by the focus motor along the optical axis of the lens group 22.

In the described structure, since the first lens frame 10, the second lens frame 20 and the third lens frame 30 are driven by cam barrels 40 and 40′, the focus motor and the rotational cam barrel 50 respectively, the coaxiality of the lens groups 12, 14, 16, 22 and 32 is accomplished by mechanical fits between several elements.

### BRIEF SUMMARY OF THE INVENTION

Therefore, each element requires higher precision and often needs to be trimmed several times for the fits.

The invention provides an optical device, wherein a focus lens frame is driven by a focus motor, and the other lens frames are driven by a driving source such as a cam barrel. As the amount of elements for fits is reduced, the accumulated error caused by fitting lens frames is thus reduced.

The optical device in accordance with an exemplary embodiment of the invention includes a base; an image sensing member disposed on the base; a cam barrel rotatably disposed on the base and having a first cam groove and a second cam groove; a first motor connected to the cam barrel for driving the cam barrel to rotate with respect to a first axis; a straight barrel disposed on the base and within the cam barrel and having at least one straight groove and parallel to the fist axis; a first lens frame bearing a first lens group and joined to the first cam groove through the straight groove; a second lens frame bearing a second lens group and movably disposed on a rail which extends axially on an inner periphery of the straight barrel; a third lens frame bearing a third lens group and joined to the second cam groove through the straight groove; and a second motor connected to the second lens frame for driving the second lens frame to move along the rail, wherein the cam barrel is configured to rotate and drive the first lens frame and the third lens frame to move along the straight groove.

In another exemplary embodiment, optical axes of the first lens frame, the second lens frame and the third lens frame are coaxial and coincide with the first axis.

In yet another exemplary embodiment, the rail is parallel to the first axis.

In yet another exemplary embodiment, the optical device further includes a screw configured to be rotated by the second motor to move the second lens frame along the rail.

In another exemplary embodiment, the second lens frame includes a first protrusion joined to the screw and a second protrusion joined to the rail.

In yet another exemplary embodiment, a plurality of teeth is formed on an outer periphery of the cam barrel, and a gear engages the teeth, and the first motor is configured to rotate the gear so as to rotate the cam barrel.

In another exemplary embodiment, the straight groove is parallel to the first axis.

In yet another exemplary embodiment, the first motor is a zoom motor.

In another exemplary embodiment, the second motor is a focus motor.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a perspective cross section of a conventional optical device; and

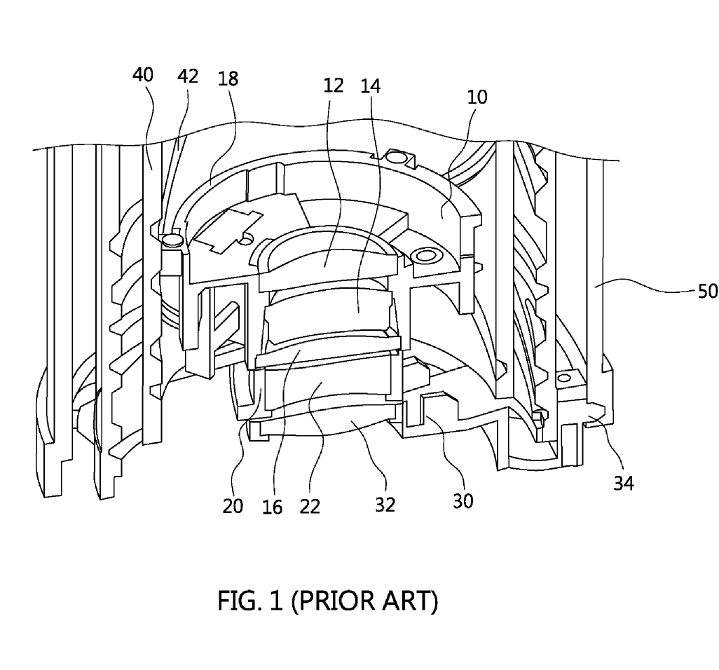

FIG. 2 is a perspective cross section of an optical device of the invention;

FIG. 3 is a cross section of an optical device of the invention; and

FIG. 4 is a perspective view of an optical device of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

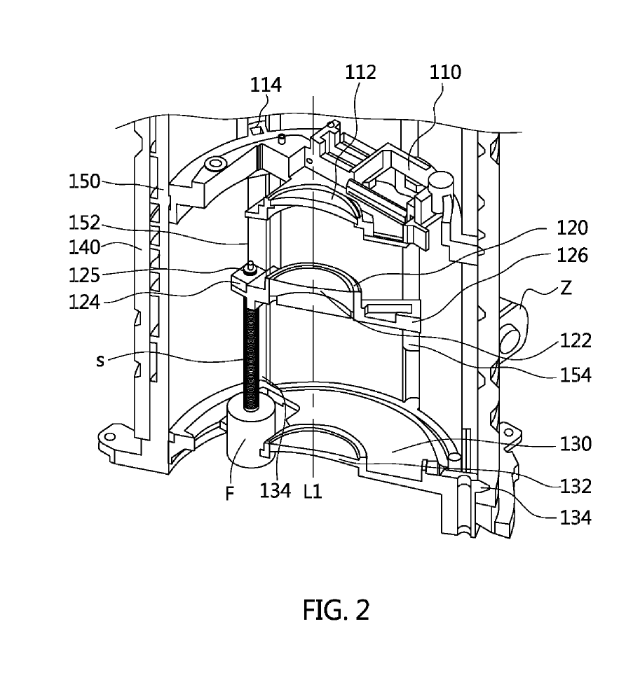

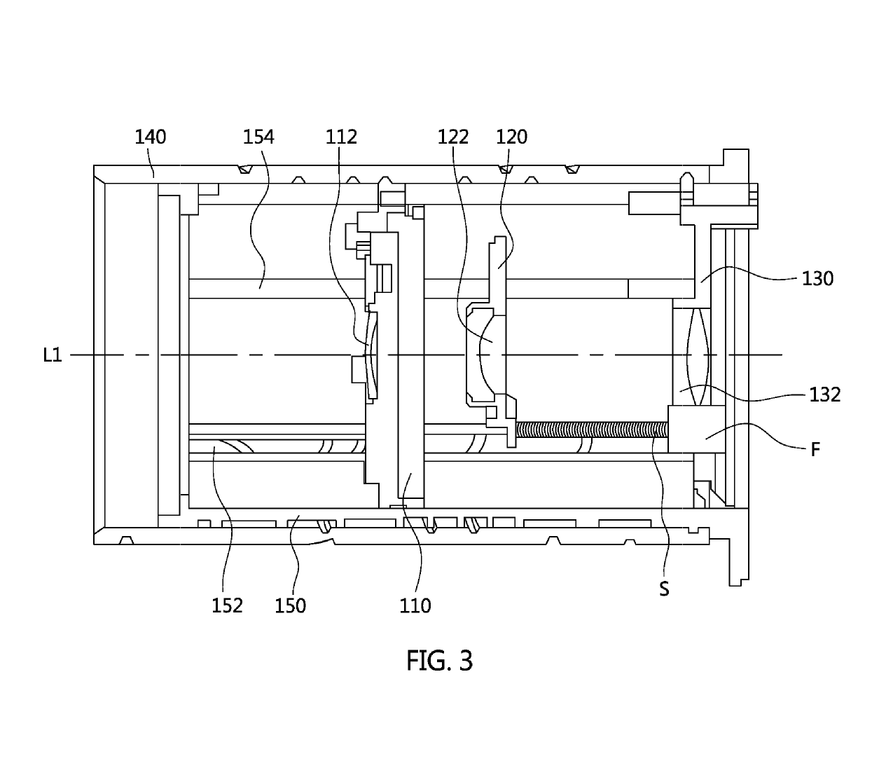

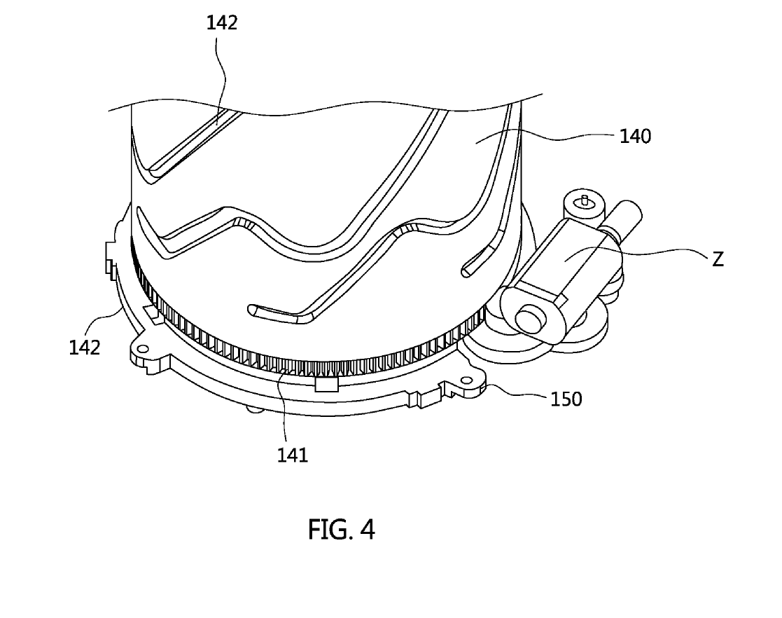

Referring to FIGS. 2, 3 and 4, an optical device of the invention includes a first lens frame 110, a second lens frame 120, a third lens frame 130, a cam barrel 140 and a straight barrel 150. Their structures are described as follows.

The straight barrel 150 is cylindrical and secured on a base (not shown) on which an image sensing member is disposed. A plurality of straight grooves 152 are formed on the straight barrel 150 and extend axially. The cam barrel 140 is disposed externally and coaxially with the straight barrel 150. A plurality of teeth 141 are formed on an outer periphery of the cam barrel 140 and engage with a gear set (not shown). The gear set is driven by a first motor Z. The first motor Z is a zoom motor in this embodiment. Thus, the first motor Z is capable of driving the cam barrel 140 to rotate with respect to a first axis L1 which extends through the image sensing member. The cam barrel 140 has a first cam groove 142 and a second can groove 143.

The first lens frame 110, the second lens frame 120 and the third lens frame 130 are disposed within the straight barrel 150 and arranged sequentially in a direction from an opening of the straight barrel 150 to a base. The first lens frame 110 bearing a first lens group 112 is a circular and fitted to an inner periphery of the straight barrel 150. The first lens frame 110 has a plurality of pins 114 extending radially outward to join the first cam groove 142 through the straight groove 152. When the cam barrel 140 rotates, the first cam groove 142 pushes the pins 114 so as to move the first lens frame 110 along the first axis L1 under the guidance of the straight grooves 152.

The second lens frame 120 is circular and bears a second lens group 122 (focus lens). The second lens frame 120 has a first protrusion 124 and a second protrusion 126. A screw hole 125 is formed on the first protrusion 124. A screw rod S engaging the screw hole 125 is connected to and rotated by a second motor F. The second motor F is a focus motor in this embodiment. The second protrusion 126 is joined to a rail 154 which is disposed on an inner periphery of the straight barrel 150 and extends axially along the straight barrel 150. The rail 154 is parallel to the first axis L1. The second motor F rotates the screw rod S so as to move the second lens frame 120 along the first axis L1 under the guidance of the rail 154.

The third lens frame 130 bearing a third lens group 132 is circular and fitted to the inner periphery of the straight barrel 150. The third lens frame 130 has a plurality of pins 134 extending radially outward to join the second cam groove 143 of the cam barrel 140 through the straight groove 152. When the cam barrel 140 rotates, the second cam groove 143 pushes the pin 134 so as to move the third lens frame 130 along the first axis L1 under the guidance of the straight grooves 152.

In the described embodiments, the first lens frame 110 and the third lens frame 130 are driven by the cam barrel 140 to move along the first axis L1, and the second lens frame 120 is driven by the second motor F to move along the first axis L1. Thus, the first lens frame 110 and the third lens frame 130 are driven by the cam barrel 140, which can reduce the accumulated error caused by assembly of lens frames and maintain the coaxiality of the lens frames easily so as to promote optical quality of the optical device.

In addition, because the second lens frame 120 is disposed between the first lens frame 110 and the third lens frame 130, the second lens frame 120 can be received in its operation space. There is no need to design an additional receiving space for the second lens frame 120, which can reduce the focusing time after startup of the optical device.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An optical device, comprising:
a base;
an image sensing member disposed on the base;
a cam barrel rotatably disposed on the base and having a first cam groove and a second cam groove;
a first motor connected to the cam barrel for driving the cam barrel to rotate with respect to a first axis;
a straight barrel disposed on the base and within the cam barrel and having at least one straight groove and parallel to the first axis;
a first lens frame bearing a first lens group and joined to the first cam groove through the straight groove;
a second lens frame bearing a second lens group and movably disposed on a rail which extends axially on an inner periphery of the straight barrel;
a third lens frame bearing a third lens group and joined to the second cam groove through the straight groove; and
a second motor connected to the second lens frame for driving the second lens frame to move along the rail, wherein the cam barrel is configured to rotate and drive the first lens frame and the third lens frame to move along the straight groove.

2. The optical device as claimed in claim 1, wherein optical axes of the first lens frame, the second lens frame and the third lens frame are coaxial and coincide with the first axis.

3. The optical device as claimed in claim 2, wherein the rail is parallel to the first axis.

4. The optical device as claimed in claim 3 further comprising a screw configured to be rotated by the second motor to move the second lens

5. The optical device as claimed in claim 4, wherein the second lens frame comprises a first protrusion joined to the screw and a second protrusion joined to the rail.

6. The optical device as claimed in claim 1, wherein a plurality of teeth is formed on an outer periphery of the cam barrel, and a gear engages the teeth, and the first motor is configured to rotate the gear so as to rotate the cam barrel.

7. The optical device as claimed in claim 2, wherein a plurality of teeth is formed on an outer periphery of the cam barrel, and a gear engages the teeth, and the first motor is configured to rotate the gear so as to rotate the cam barrel.

8. The optical device as claimed in claim 3, wherein a plurality of teeth is formed on an outer periphery of the cam barrel, and a gear engages the teeth, and the first motor is configured to rotate the gear so as to rotate the cam barrel.

9. The optical device as claimed in claim 4, wherein a plurality of teeth is formed on an outer periphery of the cam barrel, and a gear engages the teeth, and the first motor is configured to rotate the gear so as to rotate the cam barrel.

10. The optical device as claimed in claim 5, wherein a plurality of teeth is formed on an outer periphery of the cam barrel, and a gear engages the teeth, and the first motor is configured to rotate the gear so as to rotate the cam barrel.

11. The optical device as claimed in claim 1, wherein the first motor is a zoom motor.

12. The optical device as claimed in claim 1, wherein the second motor is a focus motor.
